(19) United States
(12) Patent Application Publication
(10) Pub. No.: US 2009/0268699 A1
(43) Pub. Date: Oct. 29, 2009

(54) WIRELESS COMMUNICATION APPARATUS AND WIRELESS COMMUNICATION CONTROLLING METHOD

(75) Inventor: Kei Takahashi, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/395,382

(22) Filed: Feb. 27, 2009

(30) Foreign Application Priority Data
Apr. 25, 2008 (JP) 2008-115891

(51) Int. Cl. H04J 3/00

(52) U.S. Cl. 370/336

(57) ABSTRACT

According to one embodiment, an information processing apparatus includes a wireless communication module, a communication traffic monitoring module and a management module. The wireless communication module is capable of time-dividing an identical wireless communication frame generated periodically to perform plural wireless communication with a respective plurality of different protocols in parallel. The communication traffic monitoring module monitors at least one of data traffic amounts required by the respective instances of plural wireless communication. And, the management module manages allocation of the wireless communication frame between the plurality of protocols based on the data traffic monitored by the communication traffic monitoring module.

### CROSS-REFERENCE TO RELATED APPLICATIONS

This application is based upon and claims the benefit of priority from Japanese Patent Application No. 2008-115891, filed Apr. 25, 2008, the entire contents of which are incorporated herein by reference.

### BACKGROUND

1. Field

One embodiment of the invention relates to wireless communication control techniques for effectively performing wireless communication compliant with, e.g., an ultra-wideband (UWB) standard.

2. Description of the Related Art

In recent years, many information processing apparatuses such as a personal computer have been incorporating wireless communication functions. For example, offices are often provided with local area network (LANs) for the purpose of resource sharing and the like, and cableless communication can facilitate changing office layout.

Following this trend, various proposals have heretofore been made, for example, for effectively performing wireless communication between a personal computer and a plurality of peripheral devices (for example, see Jpn. Pat. Appln. Publication No. 2006-217476 and others).

UWB standards have started to draw attention recently as the standards for performing wireless communication on a personal computer and the like. The UWB standards adopt techniques capable of time-dividing and sharing a predetermined frequency band between a plurality of wireless communication apparatuses. Since a frequency band can be time-divided for use, it is even possible for a single wireless communication apparatus to perform plural wireless communication with a respective plurality of different protocols in parallel by using the same frequency band.

For example, assume that a personal computer including both Wireless USB and Wireless DVI/Audio capabilities performs wireless communication with a mouse via Wireless USB while performing wireless communication with a display monitor via Wireless DVI/Audio.

Performing the two instances of wireless communication with the Wireless USB protocol and the Wireless DVI/Audio protocol in parallel, the personal computer needs to allocate an identical frequency band between Wireless USB and Wireless DVI/Audio. In such cases, the allocation is often based on predetermined fixed proportions.

The fixed allocation of a frequency band regardless of the amounts of data communication actually required by the respective protocols, however, is not preferable in view of effective use of the frequency band.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a mode of use of an information processing apparatus (PC) according to an embodiment of the invention;

FIG. 2 is an exemplary diagram showing a configuration pertaining to wireless communication compliant with UWB standards of according to the embodiment;

FIG. 3 is an exemplary diagram showing a superframe for use in UWB;

FIG. 4 is an exemplary diagram showing band group allocations for use in UWB;

FIG. 5 is an exemplary diagram showing a configuration of a TFC number for use in UWB;

FIG. 6 is an exemplary diagram showing a UWB priority setting screen of the information processing apparatus according to the embodiment;

FIG. 7 is an exemplary schematic diagram showing the superframe of FIG. 3 in units of MASs;

FIG. 8 is an exemplary first diagram showing a specific MAS allocation of a superframe with the schematic diagram of FIG. 4;

FIG. 9 is an exemplary second diagram showing a specific MAS allocation of a superframe with the schematic diagram of FIG. 4;

FIG. 10 is an exemplary third diagram showing a specific MAS allocation of a superframe with the schematic diagram of FIG. 4; and

FIG. 11 is an exemplary flowchart showing a procedure for optimizing the allocation of a wireless communication frame between protocols performed by the information processing apparatus according to the embodiment.

### DETAILED DESCRIPTION

Various embodiments according to the invention will be described hereinafter with reference to the accompanying drawings. In general, according to one embodiment of the invention, an information processing apparatus includes a wireless communication module, a communication traffic monitoring module and a management module. The wireless communication module is capable of time-dividing an identical wireless communication frame generated periodically to perform plural wireless communication with a respective plurality of different protocols in parallel. The communication traffic monitoring module monitors at least one of data traffic amounts required by the respective instances of plural wireless communication. And, the management module manages allocation of the wireless communication frame between the plurality of protocols based on the data traffic monitored by the communication traffic monitoring module.

Assume here that the information processing apparatus of the invention is implemented as a personal computer (PC) which includes wireless communication functions for performing wireless communication compliant with UWB standards.

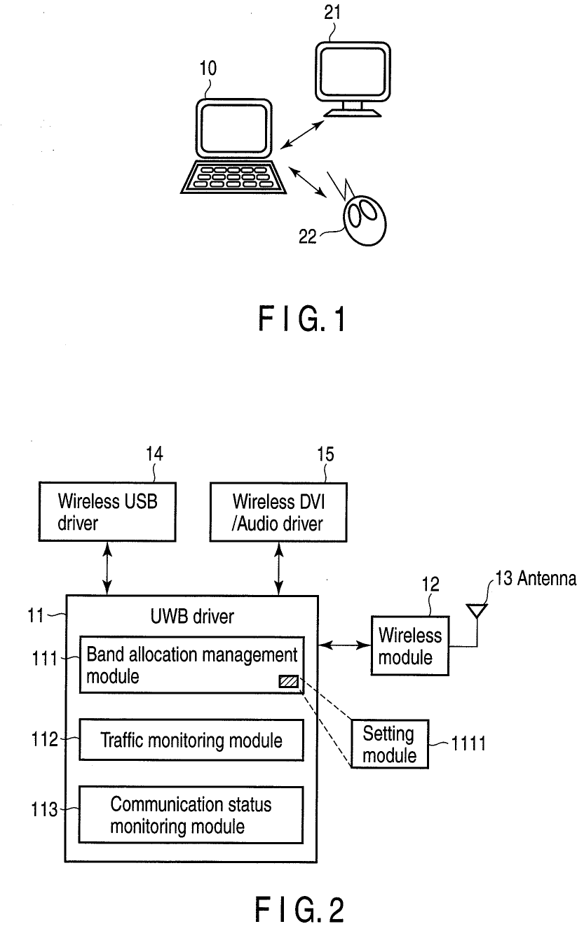

FIG. 1 is an exemplary diagram showing a mode of use of a PC 10 according to the embodiment. As shown in FIG. 1, the PC 10 performs wireless communication with a DVI display 21 while performing wireless communication with a mouse 22 as well. It will be assumed that the wireless communication with the DVI display 21 is compliant with Wireless DVI/Audio, and the wireless communication with the mouse 22 is compliant with Wireless USB. That is, the PC 10 performs two instances of wireless communication in parallel, using the Wireless DVI/Audio protocol and the Wireless USB protocol.

FIG. 2 is an exemplary diagram showing a configuration of the PC 10 pertaining to wireless communication compliant with the UWB standards. To perform wireless communication compliant with the UWB standards, as shown in FIG. 2, the PC 10 includes a UWB driver 11, a wireless module 12, an antenna 13, a Wireless USB driver 14, a Wireless DVI/Audio driver 15, etc.

When an application program or the like operating on this PC 10 outputs image data to the DVI display 21, it requests the Wireless DVI/Audio driver 15 to transmit the image data. When an application program or the like operating on the PC 10 inputs operation data from the mouse 22, it requests the Wireless USB driver 14 to receive the operation data. Receiving these requests for data transmission/reception, the Wireless USB driver 14 and the Wireless DVI/Audio driver 15 each transmit the requests to the UWB driver 11. The UWB driver 11 then drives and controls the wireless module 12 to perform the requested data transmission/reception through the antenna 13.

This UWB driver 11 includes a band allocation management module 111, a traffic monitoring module 112, a communication status monitoring module 113, etc.

The band allocation management module 111 provides management for allocating wireless communication frames (superframes) to be described later between Wireless USB and Wireless DVI/Audio in appropriate ratios. The PC 10 will not allocate the superframes in predetermined fixed proportions. Instead, this band allocation management module 111 can optimize the ratios depending on the situation each time. In this respect, detailed description will be given below.

In order for the band allocation management module 111 to optimize the superframe allocation, the traffic monitoring module 112 monitors the amounts of data transmission and reception requested by the Wireless USB driver 14 and the Wireless DVI/Audio driver 15, respectively. The communication status monitoring module 113 obtains, for example, the signal intensities during data transmission and reception from the wireless module 12, and monitors the communication statuses all the time. Based on the results of monitoring by the traffic monitoring module 112 and the communication status monitoring module 113, the band allocation management module 111 performs optimization on the superframe allocation.

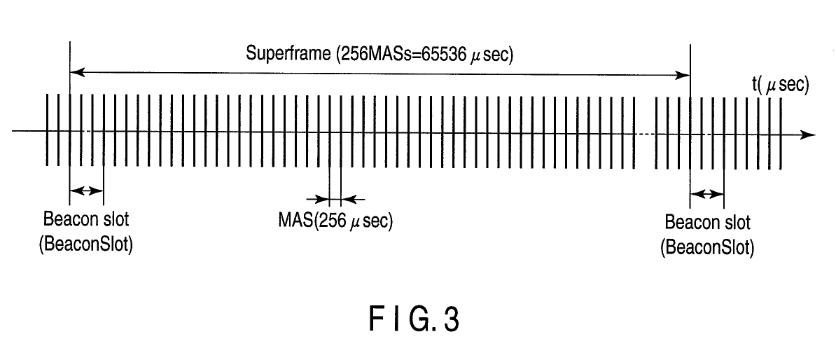

Now, referring to FIGS. 3 to 5, description will be given of the superframes which are created for the sake of performing wireless communication compliant with the UWB standards.

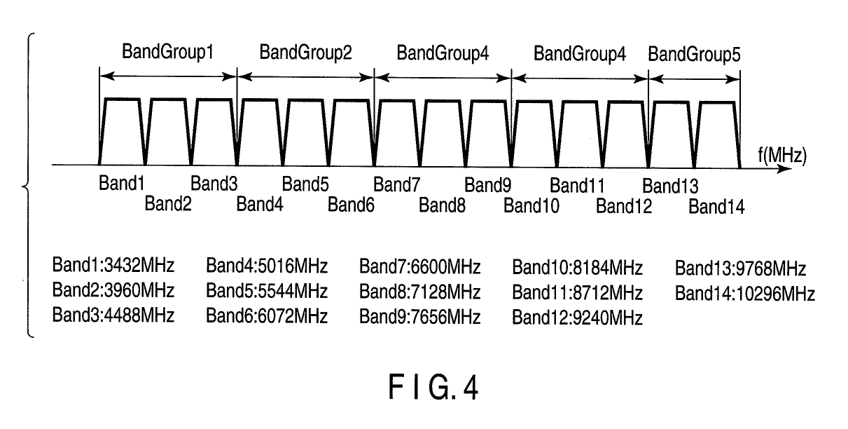

FIG. 3 shows the structure of a superframe. Each superframe (65536 μsec) has a beacon slot at the top. A single frame lasts from one beacon slot to the next beacon slot. Each frame is managed in units of MASs, with 256 μsec as one MAS (i.e., one superframe consists of 256 MASs). Note that superframes are not fixed to a certain frequency band within the frequency band for use in UWB. FIG. 4 is an exemplary diagram showing band group allocations for use in UWB.

The UWB frequency band ranges between 3.1 and 10.6 GHz, and is divided into 528 MHz per band. Every three bands are grouped into a band group (except band group 5), and communication is performed in units of these band groups. Each group of a plurality of wireless communication apparatuses that exchange data with each other (here, the PC 10, the DVI display 21, and the mouse 22) selects one band group, and performs communication by frequency hopping based on a time frequency code (TFC) number to be described later. This frequency hopping avoids chronic communication conflicts with other groups that select the same band group.

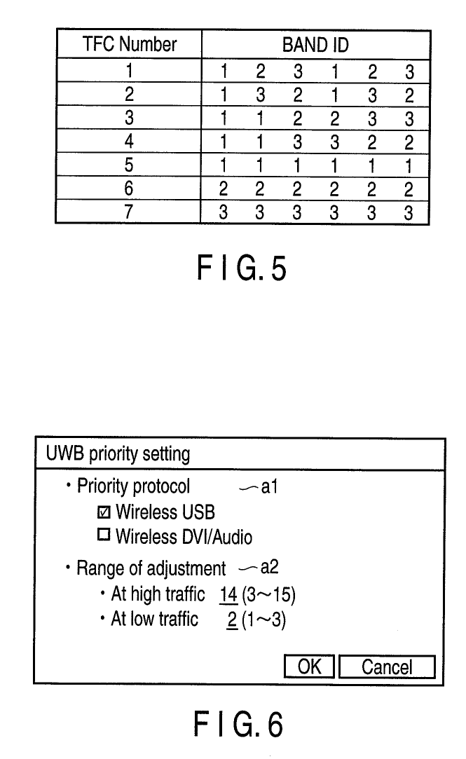

FIG. 5 shows an example of configuration of the TFC number. For example, if a group that selects band group 1 uses TFC number 1, it performs communication by frequency hopping in the pattern of band 1, band 2, band 3, band 1, . . . . As shown in FIG. 5, the hopping pattern of bands to be used for communication varies from one TFC number to another. This can avoid chronic frequency conflicts with the other groups that select the same band group 1.

The superframe shown in FIG. 3 is thus logically formed by a plurality of wireless communication apparatuses that use the same band group and the same TFC number performing frequency hopping in synchronization with each other. It is therefore theoretically possible to create as many superframes as the number of band groups×the number of TFC numbers within the UWB frequency band.

The allocation of superframes created as above is optimized by the band allocation management module 111, which includes a setting module 1111. FIG. 6 is an exemplary diagram showing a UWB priority setting screen which is displayed by a utility program or the like running on the PC 10. From this screen, the user enters setting information to be retained in the setting module 1111.

As shown in FIG. 6, this UWB priority setting screen firstly includes a field “a1” for setting which to give priority to, wireless communication via Wireless USB or wireless communication via Wireless DVI/Audio. In this field “a1”, the user can check either one of the boxes paired with the respective protocols, thereby specifying which protocol he or she wants to give priority to.

Secondly, a field “a2” is provided for setting the range (upper and lower limits) of allocation of a superframe to the protocol that is specified for priority to be given to in the field “a1”. The upper and lower limits are specified in ratios with the entire superframe as 16.

In this example of FIG. 6, the user makes the following settings: priority is given to the wireless communication via Wireless USB; the upper limit of allocation of a superframe to Wireless USB is 15/16; and the lower limit of allocation of a superframe to Wireless USB is 2/16.

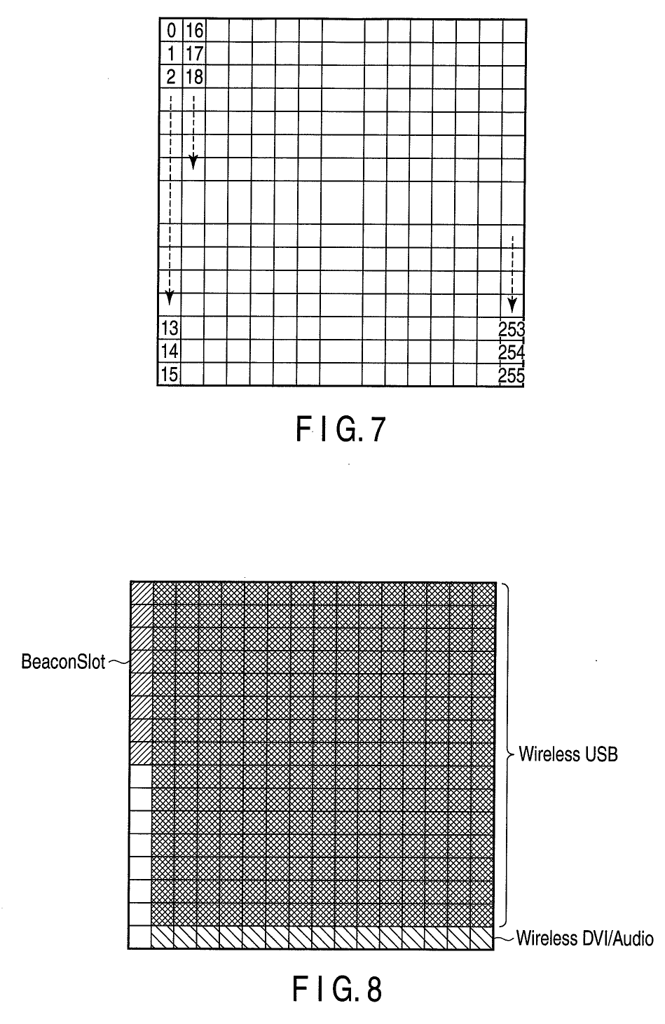

FIG. 7 is an exemplary schematic diagram showing a superframe in units of MASs. As shown in FIG. 7, a superframe is typically expressed by a two-dimensional (2D) structure of 16 rows×16 columns. The PC 10 reserves as many MASs as necessary for the wireless communication via Wireless USB and the wireless communication via Wireless DVI/Audio, respectively, in units of rows in this 2D structure shown in FIG. 7. FIGS. 8 to 10 show specific MAS allocations.

FIG. 8 is an exemplary diagram showing MAS allocations when wireless communication is performed via Wireless USB alone.

From the monitoring of the traffic monitoring module 112, the band allocation management module 111 detects that requests for data transmission/reception are being received from the Wireless USB driver 14 alone. The band allocation management module 111 then controls the allocation of a superframe as shown in FIG. 8, i.e., so that the MASs for Wireless USB and for Wireless DVI/Audio are in a ratio of 15:1.

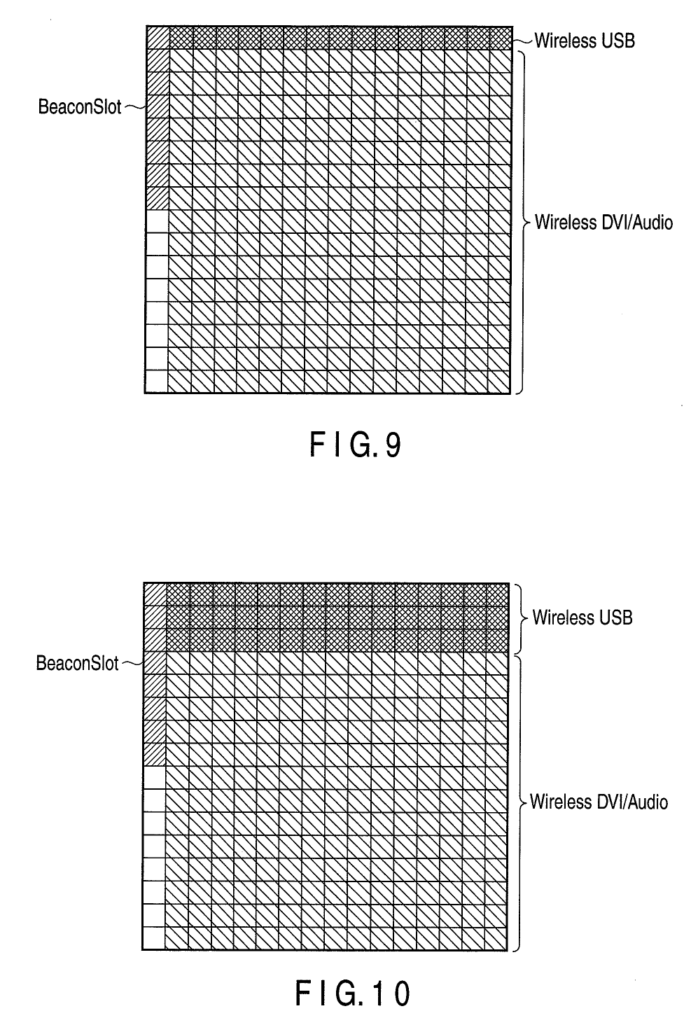

FIG. 9 is an exemplary diagram showing MAS allocations when wireless communication is performed via Wireless DVI/Audio alone.

From the monitoring of the traffic monitoring module 112, the band allocation management module 111 detects that requests for data transmission/reception are being received from the Wireless DVI/Audio driver 15 alone. The band allocation management module 111 then controls the allocation of a superframe as shown in FIG. 9, i.e., so that the MASs for Wireless USB and for Wireless DVI/Audio are in a ratio of 1:15 (contrary to FIG. 8).

FIG. 10 is an exemplary diagram showing basic MAS allocations when wireless communication is performed via Wireless USB and Wireless DVI/Audio in parallel.

From the monitoring of the traffic monitoring module 112, the band allocation management module 111 detects that requests for data transmission/reception are being received from both the Wireless USB driver 14 and the Wireless DVI/Audio driver 15. The band allocation management module 111 then controls the allocation of a superframe as shown in FIG. 10, i.e., so that the MASs for Wireless USB and for Wireless DVI/Audio are in a ratio of, e.g., 3:13.

Here, the setting of giving priority to the wireless communication via Wireless USB has been made on the UWB priority setting screen shown in FIG. 6. The band allocation management module 111 then monitors if the amount of data transmission/reception requested by the Wireless USB driver 14, which is acquired from the monitoring of the traffic monitoring module 112, exceeds a predetermined first threshold (high-traffic side) or if it falls below a second threshold (low-traffic side).

If the first threshold is exceeded, the band allocation management module 111 dynamically changes the allocation of a superframe between Wireless USB and Wireless DVI/Audio from 3:13, the basic state shown in FIG. 10, to 14:2 based on the upper limit that is set on the UWB priority setting screen shown in FIG. 6. Subsequently, when the amount of data transmission/reception requested by the Wireless USB driver 14 falls within the first threshold, the band allocation management module 111 restores the allocation of a superframe between Wireless USB and Wireless DVI/Audio to 3:13, the basic state shown in FIG. 10.

If the amount of data transmission/reception requested by the Wireless USB driver 14 falls below the second threshold, on the other hand, the band allocation management module 111 dynamically changes the allocation of a superframe between Wireless USB and Wireless DVI/Audio from 3:13, the basic state shown in FIG. 10, to 2:14 based on the lower limit that is set on the UWB priority setting screen shown in FIG. 6. Subsequently, when the amount of data transmission/reception requested by the Wireless USB driver 14 reaches the second threshold, the band allocation management module 111 restores the allocation of a superframe between Wireless USB and Wireless DVI/Audio to 3:13, the basic state shown in FIG. 10.

Along with the foregoing monitoring of the traffic monitoring module 112 as to how much data transmission/reception is requested from the Wireless USB driver 14 and the Wireless DVI/Audio driver 15, the band allocation management module 111 also monitors the communication status of the wireless communication via Wireless DVI/Audio by using the communication status monitoring module 113. For example, poor reception may cause the situation that the quality of images to be displayed on the DVI display 21 (visible to the user) cannot be maintained. The band allocation management module 111 then increases the allocation of a superframe for Wireless DVI/Audio so as to prevent the degradation of images (visible to the user), for example, when the wireless communication via Wireless DVI/Audio falls below a predetermined value in signal intensity.

Suppose, for example, that the foregoing settings have been made on the UWB priority setting screen shown in FIG. 6, and requests for data transmission/reception are being received from both the Wireless USB driver 14 and the Wireless DVI/Audio driver 15. When the communication status of the wireless communication via Wireless DVI/Audio deteriorates to or below a reference level, a further adjustment will be made so that the allocation of a superframe between Wireless USB and Wireless DVI/Audio is 13:3 if the amount of data transmission/reception requested from the Wireless USB driver 14 is above the first threshold, 2:14 if between the first and second thresholds, and 1:15 if below the second threshold.

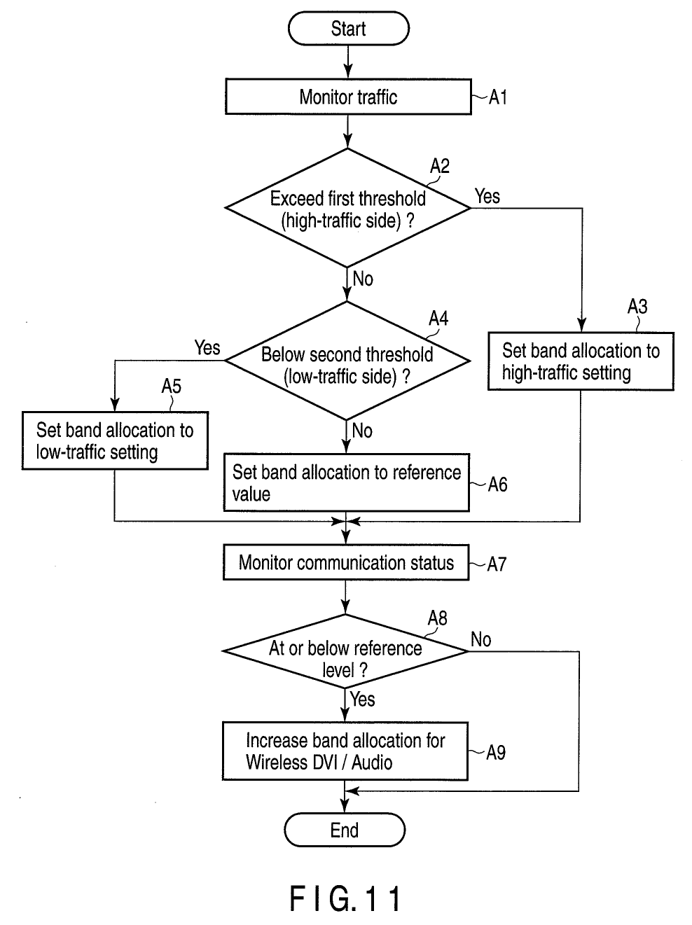

FIG. 11 is an exemplary flowchart showing a procedure for optimizing the allocation of a wireless communication frame between protocols, to be performed by the UWB driver 11 of the PC 10. It will be appreciated that this flowchart shown in FIG. 11 describes the procedure of allocating a wireless communication frame when requests for data transmission/reception are being received from both the Wireless USB driver 14 and the Wireless DVI/Audio driver 15.

Initially, the band allocation management module 111 monitors the amount of data transmission/reception requested of the wireless communication via the priority protocol, Wireless USB or Wireless DVI/Audio, through the traffic monitoring module 112 (block A1).

If the amount of data transmission/reception requested exceeds the first threshold (high-traffic side) (YES in block A2), the band allocation management module 111 makes settings to allocate the wireless communication frame between the protocols so that the upper limit is assigned to the priority protocol (block A3). On the other hand, if the amount of data transmission/reception requested falls below the second threshold (low-traffic side) (NO in block A2, YES in block A4), the band allocation management module 111 makes settings to allocate the wireless communication frame between the protocols so that the lower limit is assigned to the priority protocol (block A5).

If the amount of data transmission/reception requested falls between the first and second thresholds (NO in block A4), the band allocation management module 111 makes settings to allocate the wireless communication frame between the protocols so that the reference values are assigned to the respective protocols (block A6).

The band allocation management module 111 also monitors the communication status of the wireless communication via Wireless DVI/Audio through the communication status monitoring module 113 (block A7). If the communication status is at or below the reference level (YES in block A8), the band allocation management module 111 increases the allocation of the wireless communication frame for Wireless DVI/Audio (block A9).

As has been described above, according to this PC, the allocation of wireless communication frames between the protocols is optimized depending on the situation each time.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.
What is claimed is:

1. An information processing apparatus comprising:
a wireless communication module configured to time-divide an identical wireless communication frame periodically generated and to perform a plurality of wireless communications with a plurality of protocols in parallel respectively;
a communication traffic monitoring module configured to monitor at least one of data traffic amounts corresponding to one of the plurality of wireless communications; and
a management module configured to manage allocation of the wireless communication frame between the plurality of protocols based on the data traffic monitored by the communication traffic monitoring module.

2. The information processing apparatus of claim 1, further comprising
a priority setting module configured to set priorities among the plurality of protocols, wherein
the management module is configured to adjust the allocation of the wireless communication frame based on the data traffic to be used by a prioritized protocol by the priority setting module.

3. The information processing apparatus of claim 2, wherein the priority setting module is configured to set a substantially high ratio and a substantially low ratio for the wireless communication frame to be allocated to the prioritized protocol.

4. The information processing apparatus of claim 1, further comprising
a communication status monitoring module configured to monitor a status of wireless communication by the wireless communication module, wherein
the management module is configured to increase the allocation of the wireless communication frame to a predetermined protocol when the status of wireless communication monitored by the communication status monitoring module is indicative of a level as substantially low as or below a predetermined reference level.

5. A wireless communication controlling method of an information processing apparatus comprising a wireless communication module configured to time-divide an identical wireless communication frame periodically generated and to perform a plurality of wireless communications with a plurality of protocols in parallel respectively, the method comprising:
monitoring at least one of data traffic amounts corresponding to one of the plurality of wireless communications; and
managing allocation of the wireless communication frame between the plurality of protocols based on the monitored data traffic.

6. The wireless communication controlling method of claim 5, further comprising
setting priorities among the plurality of protocols, wherein
the allocation managing comprises adjusting the allocation of the wireless communication frames based on the data traffic to be used by a prioritized protocol set by the priority setting.

7. The wireless communication controlling method of claim 6, wherein
the priority setting comprises setting a substantially high ratio and a substantially low ratio for the wireless communication frame to be allocated to the prioritized protocol.

8. The wireless communication controlling method of claim 5, further comprising
monitoring a status of wireless communication by the wireless communication module, wherein
the allocation managing comprises increasing the allocation of the wireless communication frame to a predetermined protocol if the status of wireless communication monitored is indicative of a level as substantially low as or below than a predetermined reference level.
